(19) United States
(12) Patent Application Publication
(10) Pub. No.: US 2003/0019308 A1
(43) Pub. Date: Jan. 30, 2003

(54) Apparatus for mounting a sensor

(76) Inventors: Hans-Joachim Oppermann, Gemmrigheim (DE); Detlef Exner, Monsheim (DE)

Correspondence Address: Felix J. D'Ambrosio, JONES, TULLAR & COOPER, P.C., P.O. Box 2266 Eads Station, Arlington, VA, 22202, US

(21) Appl. No.: 10/207,170

(22) Filed: Jul. 30, 2002

(30) Foreign Application Priority Data
Jul. 30, 2001 (DE) 10137115.2

(51) Int. Cl. G01D 21/00

(52) U.S. Cl. 73/866.5

(57) ABSTRACT

The invention relates to an apparatus for aseptic mounting of a sensor (1), which determines and/or monitors at least one physical and/or chemical process variable relating to a medium (3) which is located in a container (2).

The invention is based on the object of proposing an apparatus for aseptic mounting of a sensor (1) on a container (2).

The object is achieved in that a process fitting (4) is provided, which has an internal area for holding the sensor (1), with the internal area opening into an opening (5) on that side of the process fitting which faces the process, and with a shaped seal (6) being positioned in the opening (5), which shaped seal (6) is designed such that, once the sensor (1) has been fitted, it produces a push fit in the opening (5) and seals the internal area of the process fitting (4) from the process without any gap.

The invention relates to an apparatus for mounting a sensor, which determines and/or monitors at least one physical and/or chemical process variable relating to a medium which is located in a container. The process variable relates, for example, to the temperature, the conductivity, the pH value or the oxygen content of the medium. The container may, for example, be in the form of a tank or a tube.

Instrumentation apparatuses are used widely in the foodstuffs industry. When these apparatuses come into contact with foodstuffs, they have to satisfy very stringent hygiene requirements, for obvious reasons. The hygiene requirements relating to the instrumentation apparatuses are formulated by Standards Committees. By way of example, in this context, the European Standard EN 1672-2:1997 may be mentioned, which has the status of a national German Standard. This Standard supplements the generally applicable major safety and health requirements in EU Machine Directive 89/392/EU from the European Council with detailed requirements for machines which are used in the foodstuffs industry.

Potential areas for germs which are dangerous to health to gather preferably occur in regions in which two subcomponents of a measurement apparatus are detachably connected to one another. Relatively narrow, physically small intermediate spaces are particularly critical. The contact region, facing the process, of a sensor with a process fitting may be quoted by way of example at this point. The sensor may be, for example, a pH electrode, which determines the pH value of the process medium. The sensor and the pH electrode are mounted via the process fitting on the container wall or in a pipeline, such that a direct contact is formed between the sensor and the medium. If there is a gap in the contact region between the sensor and the process fitting, then the medium can enter this gap, and can accumulate there. As is known, narrow gaps cannot be cleaned, or cannot be cleaned sufficiently well.

Seals with an optimized design have been used in an attempt to overcome the problem mentioned above: for example, EN Standard 1672-2: 1997 includes proposals on how a seal between two subcomponents of a measurement apparatus must be designed and arranged in order to satisfy the hygiene regulations in the foodstuffs industry. In particular, the proposal is made on page 15 of EN Standard 1672-2: 1997 for an O-ring to be used as the seal, and for this O-ring to be arranged as close as possible to the process medium. On the one hand, this prevents any gaps from being formed between the two subcomponents, which can be detached from one another, while on the other hand, it also ensures that the contact region can be cleaned sufficiently well. However, the Standard also refers to the fact that, due to the manufacturing tolerances with O-rings, their compression and thus the lack of any gap in the seal to the process are rather difficult to inspect.

The invention is based on the object of proposing an apparatus for aseptic mounting of a sensor on a container.

The object is achieved in that a process fitting is provided which has an internal area for holding a sensor, with the internal area opening into an opening on an outer side of the process fitting, and with a shaped seal being positioned in the opening, which shaped seal is designed such that, once the sensor has been fitted, it produces a push fit in the opening and seals the internal area of the process fitting from the process without any gap.

According to one advantageous development of the apparatus according to the invention, the opening is provided on that end surface of the process fitting which faces the process. It is particularly advantageous for the shaped seal to be essentially annular and to have an essentially planar outer surface toward the process.

In order to achieve the desired push fit in the opening, the shaped seal has a shoulder with an essentially planar outer surface on the side facing away from the process, which outer surface rests on a corresponding projection on the inner surface of the process fitting.

The shaped seal is preferably of such a size that it projects slightly beyond the outer surface or the end surface of the process fitting when the push fit in the opening is reached.

According to one preferred embodiment of the apparatus according to the invention, the shaped seal has at least one depression on its inner surface facing the sensor. The depression is advantageously annular. Since the inner surface of the shaped seal essentially has only two annular contact surfaces with the sensor, the sensor can be inserted relatively easily into the shaped seal and can be withdrawn from the shaped seal, since the stiction forces are low. Silicone, EPDM or FPM are particularly highly suitable, by way of example, as materials for the shaped seal.

In order to mount the sensor on the process fitting, a thread is provided on the sensor; a corresponding thread is provided on the inner surface of the process fitting, so that the sensor can be connected to the process fitting via a screw connection. In order to mount the apparatus according to the invention on the container, a corresponding mounting part is provided on the process fitting.

Process fittings for mounting a sensor on a container, which may be used in conjunction with the apparatus according to the invention, are already widely known from the prior art. The process fittings which are offered and marketed by the applicant under the name UniFit may be mentioned by way of example.

According to one advantageous development of the apparatus according to the invention, a leakage monitor is provided, which provides information about any leaks through the shaped seal. Such leakage seals are likewise known from the prior art and, for example, result from the requirements in the 3-A Sanitary Standard.

The invention will be explained in more detail with reference to the attached drawings, in which:

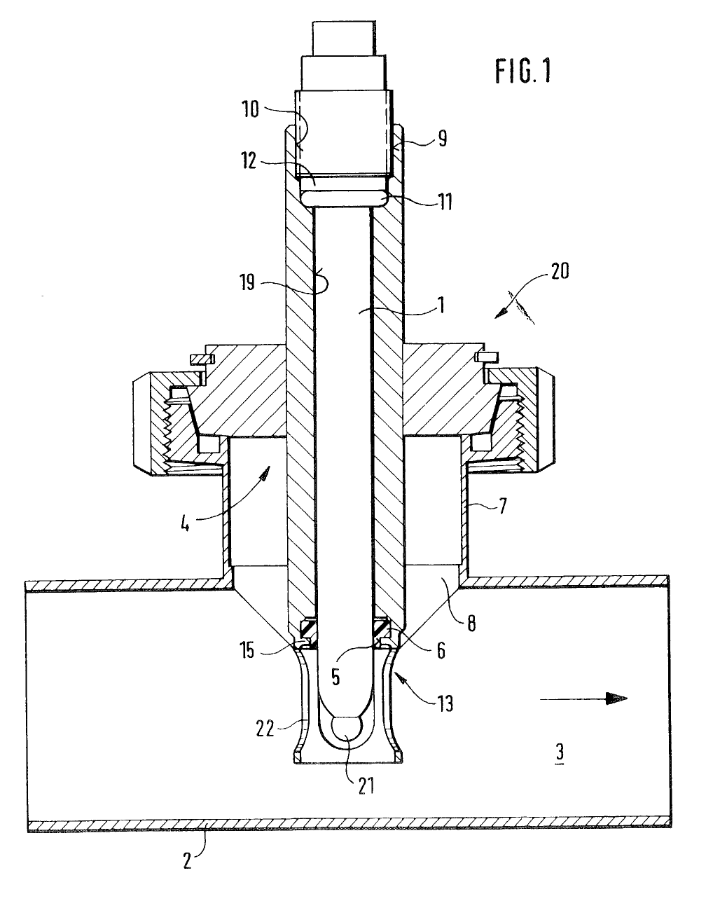

FIG. 1 shows a longitudinal section through one advantageous embodiment of the aseptic mounting apparatus according to the invention for a pH electrode,

FIG. 2 shows a perspective view of one advantageous refinement of the shaped seal,

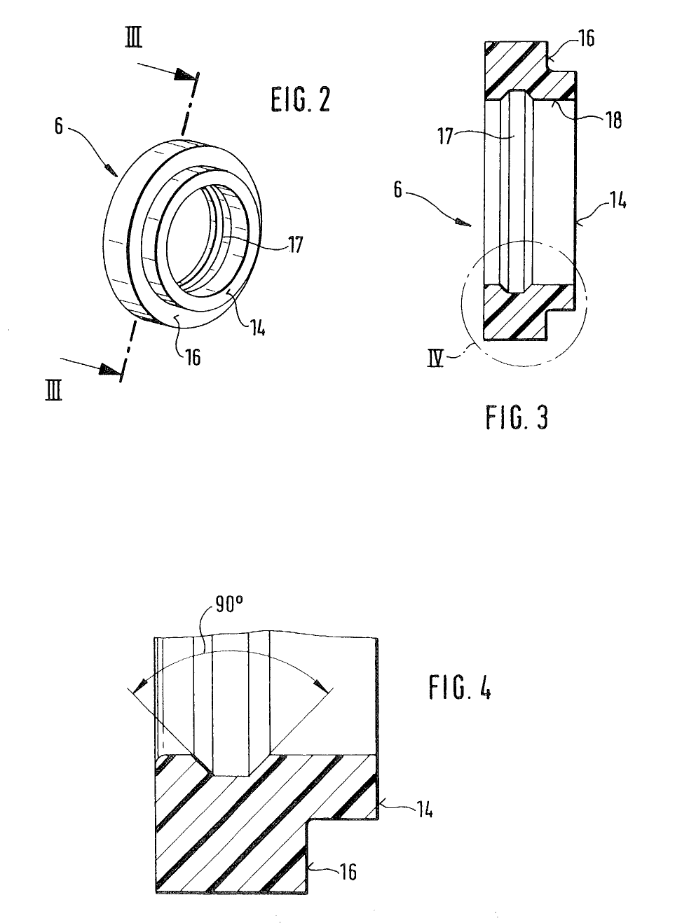

FIG. 3 shows a cross section through the shaped seal along the line III-III in FIG. 2, and

FIG. 4 shows a separate illustration of the detail of the shaped seal, as identified by X in FIG. 3.

FIG. 1 shows a longitudinal section through one advantageous embodiment of the aseptic mounting apparatus according to the invention for a pH electrode 1. In the illustrated case, the process fitting 4 is a permanently installed process fitting 4, which is offered and marketed by the applicant under the name UniFit. The process fitting 4 is firmly screwed to the mounting stub 7 via the mounting part 20. The mounting stub 7 is normally welded into a corresponding opening 8 in the container, in this case the tube 2.

A medium 3, whose pH value is determined and/or monitored by means of the pH electrode 1, flows through the tube 2. The impact protection 22 is arranged concentrically around the pH glass membrane 21 and is used to protect the pH glass membrane 21 against mechanical influences.

The internal area of the process fitting 4 is used to hold the pH electrode 1. The pH electrode 1 is mounted in the process fitting 4 such that at least the pH glass membrane 21 comes into contact, in the installed state, with the medium 3 which is flowing through the tube 2. The shaped seal 6 is provided in order to prevent particles in the medium 3 from entering the gap between the pH electrode 1 and the process fitting 4. This shaped seal 6 is positioned in the opening 5, which is located on that end surface 13 of the process fitting 4 which faces the process. The shaped seal 6 is designed such that, once the pH electrode 1 has been inserted, a push fit is produced in the opening 5, and the internal area of the process fitting 4 is thus sealed from the process without any gap. The pH electrode is introduced into the process fitting 4 from the side facing away from the process, and is then secured in the process fitting 4 by means of a screw connection 9, 10.

One advantageous refinement of the shaped seal 6 can be seen in detail in FIG. 2 to FIG. 4. While FIG. 2 shows a perspective view of the shaped seal 6, FIG. 3 shows a cross section through the shaped seal along the line III-III in FIG. 2. The detail which is identified by X in FIG. 3 is illustrated once again, separately, in FIG. 4.

The shaped seal 6 is essentially annular and has an essentially planar outer surface 14 toward the process. In order to achieve the desired push fit in the opening 5, the shaped seal 6 has a shoulder 16, with an essentially planar outer surface, on the side facing away from the process. The shoulder 16 of the shaped seal 6 rests against a corresponding projection 23 on the inner surface 19 of the process fitting 4. The shaped seal 6 is preferably of such a size that it projects slightly beyond the end surface 13 of the process fitting 4 once the push fit has been produced in the opening 5.

As can be seen from FIG. 3 and FIG. 4, the shaped seal 6 has at least one depression 17 on its inner surface 18 facing the sensor 1. The depression 17 is advantageously annular. Since the inner surface 18 of the shaped seal 6 essentially has only two annular contact surfaces with the sensor 1, the sensor 1 can be inserted relatively easily into the shaped seal 6 and into the process fitting 4, and can be removed from the shaped seal 6 and from the process fitting 4, since the stiction force is small. Silicone, EPDM or FPM may be used, by way of example, as suitable materials for the shaped seal 6.

### List of Reference Symbols

1 pH electrode

2 Tube

3 Medium

4 Process fitting

5 Opening

6 Shaped seal

7 Mounting stub

8 Opening in the container

9 External thread

10 Internal thread

11 O-ring

12 Seal

13 End surface of the process fitting

14 Outer surface of the shaped seal

15 Projection

16 Shoulder

17 Depression

18 Inner surface of the shaped seal

19 Inner surface of the process fitting

20 Mounting part

21 pH glass membrane

22 Impact protection

1. An apparatus for aseptic mounting of a sensor (1), which determines and/or monitors at least one physical and/or chemical process variable relating to a medium (3) which is located in a container (2),
having a process fitting (4), which has an internal area for holding the sensor (1), with the internal area opening into an opening (5) on that side of the process fitting which faces the process, and with a shaped seal (6) being positioned in the opening (5), which shaped seal (6) is designed such that, once the sensor (1) has been fitted, it produces a push fit in the opening (5) and seals the internal area of the process fitting (4) from the process without any gap.

2. The apparatus as claimed in claim 1,
with the opening (5) being provided on that end surface (13) of the process fitting (4) which faces the process.

3. The apparatus as claimed in claim 1,
with the shaped seal (6) being essentially annular and having an essentially planar outer surface (14) toward the process.

4. The apparatus as claimed in claim 1 or 3,
with the shaped seal (6) having a shoulder (16) with an essentially planar outer surface (14) on the side facing away from the process, which outer surface (14) rests on a corresponding projection (15) on the inner surface (18) of the process fitting (4).

5. The apparatus as claimed in claim 1, 2, 3 or 4, with the shaped seal (6) having at least one depression (17) on its inner surface (18) facing the sensor (1).

6. The apparatus as claimed in claim 5,
with the depression (17) being annular.

7. The apparatus as claimed in one or more of the preceding claims,
with the shaped seal (6) being composed of silicone, EPDM or FPM.

8. The apparatus as claimed in claim 1,
with a thread (9) being provided on the sensor, with a corresponding thread (10) being provided on the inner surface (18) of the process fitting (4), and with the sensor (1) being connected to the process fitting (4) via the screw connection (9, 10).

9. The apparatus as claimed in claim 1 or 8,
with a mounting part (20) being provided on the process fitting (4), via which mounting part (20) the process fitting (4) can be mounted, with the sensor (1), on the container (2).

10. The apparatus as claimed in claim 1,
with a leakage monitor being provided, which provides information about any leaks through the shaped seal (6).
